(19) United States
(12) Patent Application Publication
(10) Pub. No.: US 2016/0372152 A1
(43) Pub. Date: Dec. 22, 2016

(54) GB/GBC/GBA Game Case - Universal Hand held Game Case

(71) Applicant: Jeremy Michael Gann, Las Vegas, NV (US)

(72) Inventor: Jeremy Michael Gann, Las Vegas, NV (US)

(21) Appl. No.: 14/743,824

(22) Filed: Jun. 18, 2015

(51) Int. Cl. G11B 23/023; F16B 2/22

(52) U.S. Cl. CPC G11B 23/0233; F16B 2/22

(57) ABSTRACT

One clips system enabling a variety of game cartridges to be contained securely in game cases.

### CROSS REFERENCE

Application Ser. No. 61/998,619

### Filing Date Jul. 5, 2014

### BACKGROUND PRIOR ART

The disadvantages of prior art is the limited scope of application, not applicable to game cartridges as it is made for memory cards.

The advantages of my clip invention is that it grands the ability to firmly house varied sized game cartridges with holding clips.

### SUMMARY

A housing system to hold various game cartridges in a case.

### DETAILED DESCRIPTION

Housing enclosed in plastic video game cases with clips that secure a variety of types and sizes of game cartridges.

### OPERATION

### First Embodiment

The manor of using the game case to hold game cartridges is unique due to the internal clip structure which grants the ability to firmly house varied size game cartridges.

### DRAWING

### Figures

The drawings show some perspective views of the game case clips.

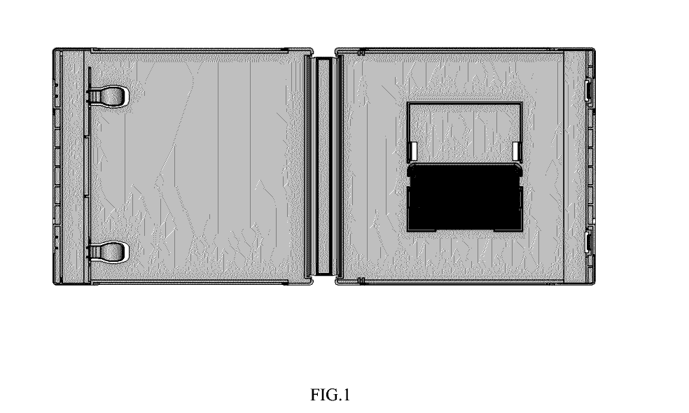

FIG. 1 is a perspective view of a game case showing our clip design.

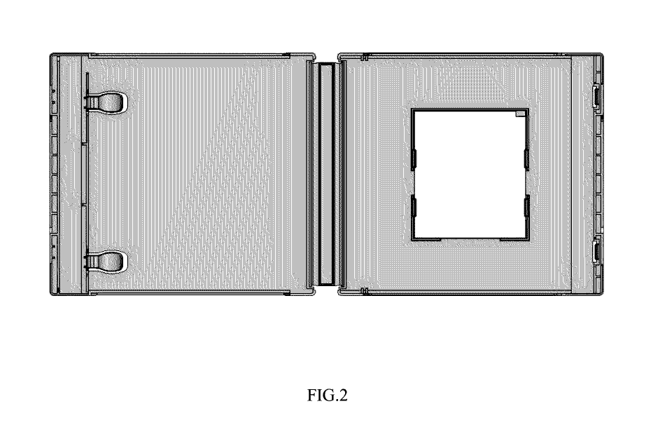

FIG. 2 is a perspective view of an alternate game case showing our clip design.

The drawings show some perspective views of the game case clips.

FIG. 1 is a perspective view of a game case showing our clip securing a game cartridge.

FIG. 2 is a perspective view of the same game case with our clip securing an alternate game case cartridge.

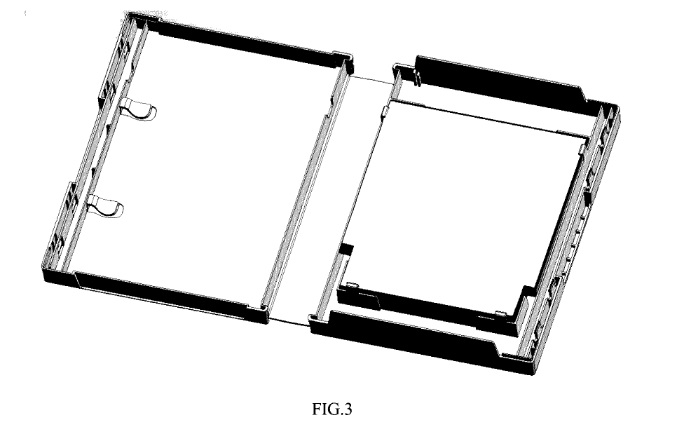

FIG. 3 is a perspective view of an alternate game case showing our clip securing an alternate game cartridge.

### CONCLUSION, RAMIFICATIONS, AND SCOPE

This clip system proficiently allows a variety of shapes and sizes of game cartridges to be secured in video game cases.

1. The grasping clip design securely holds various sizes and shapes of video game ROM cartridges in place while housed in a game case.
